(19) United States
(12) Patent Application Publication
(10) Pub. No.: US 2025/0033382 A1
(43) Pub. Date: Jan. 30, 2025

(54) IMAGE RECORDING APPARATUS

(71) Applicant: BROTHER KOGYO KABUSHIKI KAISHA, Nagoya (JP)

(72) Inventor: WATARU SUGIYAMA, Nishio (JP)

(73) Assignee: BROTHER KOGYO KABUSHIKI KAISHA, Nagoya (JP)

(21) Appl. No.: 18/785,222

(22) Filed: Jul. 26, 2024

(30) Foreign Application Priority Data
Jul. 28, 2023 (JP) 2023-123146

(51) Int. Cl. B41J 11/00; B41J 11/66; B41J 11/70; B41J 15/04; B41J 29/13; B65H 16/02; B65H 20/02

(52) U.S. Cl. CPC B41J 11/0095; B41J 11/663; B41J 11/70; B41J 15/046; B41J 15/048; B41J 29/13; B65H 16/028; B65H 20/02

(57) ABSTRACT

An image recording apparatus includes: a first accommodating part which accommodates a first medium; a second accommodating part which accommodates a second medium; a conveyor which selectively conveys the first medium and the second medium in a conveying direction; and a recording part which records an image on a medium conveyed by the conveyor. The conveyor has roller pairs including a first roller pair and second roller pairs. The first roller pair is disposed upstream of the recording part in the conveying direction. Each of the second roller pairs is disposed upstream of the first roller pair in the conveying direction. The first medium is conveyed along a first conveyance path and the second medium is conveyed along a second conveyance path. The first and second conveyance paths join at a joining point between the first roller pair and the second roller pairs in the conveying direction.

### REFERENCE TO RELATED APPLICATIONS

This application claims priority from Japanese Patent Application No. 2023-123146 filed on Jul. 28, 2023. The entire content of the priority application is incorporated herein by reference.

### BACKGROUND ART

Conventionally, an image forming apparatus (image recording apparatus) including two sheet feeding devices (first accommodating part and second accommodating part) each capable of accommodating a roll sheet (medium), and an image forming part (recording part) which forms an image on a sheet unwound from the roll sheet, is known. In the image forming apparatus, routes (first conveyance path and second conveyance path) along which sheets are conveyed from the two sheet feeding devices toward the image forming part join at a joining point disposed upstream in the conveying direction of a sheet feeding roller (second roller pair) disposed in a sheet feeding device which is on a first stage in the two sheet feeding devices.

### SUMMARY

In order to quickly switch the medium which is an object of recording from the first medium to the second medium, such a configuration can be considered wherein the second medium is caused to stand by, in a state that a forward end of the second medium is located immediately upstream of the joining point while recording is being performed on the first medium. However, in a case where the joining point is disposed upstream in the conveying direction with respect to the second roller pair as in the above-described image forming apparatus, the length of a route from the joining point to the recording part is long, and thus recording after the switching cannot be performed quickly.

An object of the present disclosure is to provide an image recording apparatus capable of quickly switching the medium, which serves as the object of recording, from the first medium to the second medium.

An image recording apparatus according to an aspect of the present disclosure includes: a first accommodating part configured to accommodate a first medium; a second accommodating part configured to accommodate a second medium, the first accommodating part and the second accommodating part being arranged in an up-down direction; a conveyor configured to selectively convey the first medium and the second medium in a conveying direction; and a recording part configured to record an image on a medium conveyed by the conveyor. The conveyor has a plurality of roller pairs which are separated from each other in the conveying direction. The roller pairs include a first roller pair and a plurality of second roller pairs. The first roller pair is disposed upstream of the recording part in the conveying direction, without another roller pair being interposed between the recording part and the first roller pair in the conveying direction. Each of the second roller pairs is disposed upstream of the first roller pair in the conveying direction, without another roller pair being interposed between the first roller pair and each of the second roller pairs in the conveying direction. The first medium is conveyed by the conveyor from the first accommodating part toward the recording part along a first conveyance path and the second medium is conveyed by the conveyor from the second accommodating part toward the recording part along a second conveyance path. The first conveyance path and the second conveyance path join at a joining point disposed between the first roller pair and the second roller pairs in the conveying direction.

According to the present disclosure, the joining point is disposed between the first roller pair and the second roller pairs in the conveying direction. Therefore, in a case where switching of the medium as an object of recording is performed from the first medium to the second medium, the second medium which is caused to stand by in a state that the forward end of the second medium is located in the vicinity of the upstream side of the joining point can be quickly conveyed toward the first roller pair and the recording part. Therefore, according to the present disclosure, the switching of the medium as the object of recording can be performed quickly from the first medium to the second medium.

### BRIEF DESCRIPTION OF DRAWINGS

FIG. 1 is a schematic view of a printer according to an embodiment of the present disclosure.

FIG. 2 is a block diagram depicting electrical configuration of the printer of FIG. 1.

FIGS. 3A and 3B are schematic views depicting the configuration in the vicinity of a grip part of a first sheet feed tray of the printer in FIG. 1.

FIG. 4 is a flow chart of a first program executed by a CPU of the printer in FIG. 1.

FIG. 5 is a flowchart of a second program executed by the CPU of the printer in FIG. 1.

### DESCRIPTION

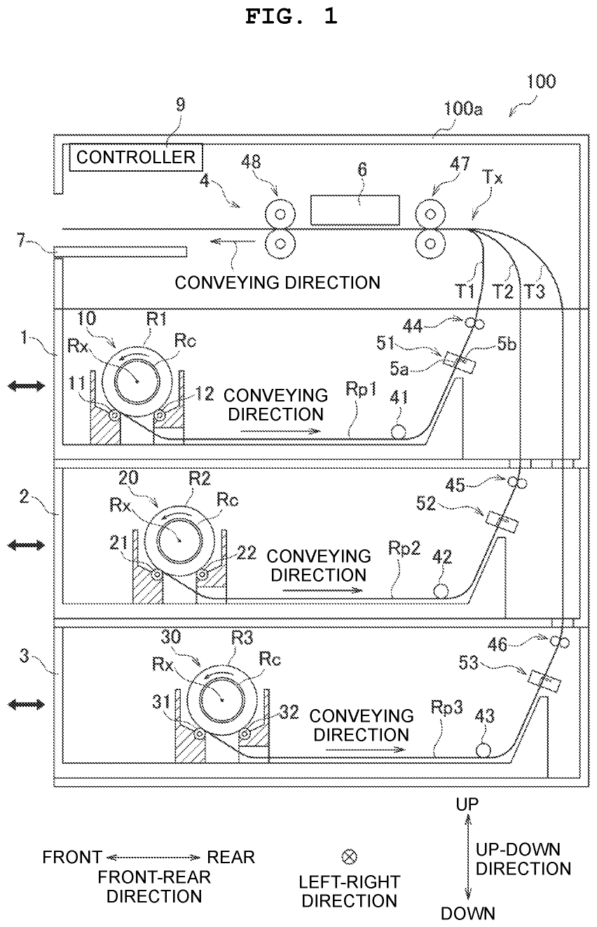

A printer 100 depicted in FIG. 1 is an embodiment of an “image recording apparatus” according to the present disclosure. The printer 100 includes a casing 100a, a first sheet feed tray 1, a second sheet feed tray 2, a third sheet feed tray 3, a conveyor 4, a first cutting part 51, a second cutting part 52, a third cutting part 53, a head 6, a sheet discharge tray 7, and a controller 9.

The first sheet feed tray 1 corresponds to a “first tray” of the present disclosure, and the second sheet feed tray 2 corresponds to a “second tray” of the present disclosure.

Each of the first sheet feed tray 1, the second sheet feed tray 2, and the third sheet feed tray 3 is movable in the front-rear direction with respect to the casing 100a, and can take an attachment position (see FIG. 1) at which each of the first sheet feed tray 1, the second sheet feed tray 2, and the third sheet feed tray 3 is attached to casing 100a, and a drawn position (not depicted) which is in front of the attachment position and at which each of the first sheet feed tray 1, the second sheet feed tray 2, and the third sheet feed tray 3 is drawn from the casing 100a. The attachment position of the first sheet feed tray 1 corresponds to a “first attachment position” of the present disclosure, and the attachment position of the second sheet feed tray 2 corresponds to a “second attachment position” of the present disclosure. The drawn position of the first sheet feed tray 1 corresponds to a “first drawn position” of the present disclosure, and the drawn position of the second sheet feed tray 2 corresponds to a “second drawn position” of the present disclosure.

The first sheet feed tray 1 has a first accommodating part 10 capable of accommodating a roll body R1. The second sheet feed tray 2 has a second accommodating part 20 capable of accommodating a roll body R2. The third sheet feed tray 3 has a third accommodating part 30 capable of accommodating a roll body R3.

The first to third sheet feed trays 1 to 3 are arranged in the up-down direction, each at the attachment position depicted in FIG. 1. Therefore, the first to third accommodating parts 10 to 30 are arranged in the up-down direction. Among the first to third sheet feed trays 1 to 3, the first sheet feed tray 1 is disposed uppermost, the third sheet feed tray 3 is disposed lowermost, and the second sheet feed tray 2 is disposed between the first sheet feed tray 1 and the third sheet feed tray 3 in the up-down direction.

The roll bodies R1 to R3 have mutually same configurations, and each of the roll bodies R1 to R3 is formed by winding a long roll sheet Rp1, Rp2 or Rp3 in a roll shape around the outer circumferential surface of a cylindrical core member Rc. The roll sheet Rp1 unwound from the roll body R1 corresponds to a “first medium” of the present disclosure, and the roll sheet Rp2 unwound from the roll body R2 corresponds to a “second medium” of the present disclosure. The roll bodies R1 to R3 are accommodated, respectively, in the accommodating parts 10 to 30, in a state that an axis Rx of the core member Rc extends in the left-right direction.

Two rollers 11 and 12 constructing the conveyor 4 are disposed at a bottom part of the first accommodating part 10. Each of the two rollers 11 and 12 is rotatable about an axis extending in the left-right direction. In a case where the roll body R1 is accommodated in the first accommodating part 10, the outer circumferential surface in a lower part of the roll body R1 is supported by the two rollers 11 and 12.

Two rollers 21 and 22 constructing the conveyor 4 are disposed at a bottom part of the second accommodating part 20. Each of the two rollers 21 and 22 is rotatable about an axis extending in the left-right direction. In a case where the roll body R2 is accommodated in the second accommodating part 20, the outer circumferential surface in a lower part of the roll body R2 is supported by the two rollers 21 and 22.

Two rollers 31 and 32 constructing the conveyor 4 are disposed in a bottom part of the third accommodating part 30. Each of the two rollers 31 and 32 are rotatable about an axis extending in the left-right direction. In a case where the roll body R3 is accommodated in the third accommodating part 30, the outer circumferential surface in a lower part of the roll body R3 is supported by the two rollers 31 and 32.

The sheet discharge tray 7 is disposed above the first sheet feed tray 1 and is fixed with respect to the casing 100a.

The conveyor 4, the first to third cutting parts 51 to 53, the head 6, and the controller 9 are accommodated within the casing 100a.

The conveyor 4 is configured to selectively convey the roll sheets Rp1 to Rp3. The conveyor 4 has a first conveyance path T1 along which the roll sheet Rp1 is conveyed from the first accommodating part 10 toward the head 6, a second conveyance path T2 along which the roll sheet Rp2 is conveyed from the second accommodating part 20 toward the head 6, and a third conveyance path T3 along which the roll sheet Rp3 is conveyed from the third accommodating part 30 toward the head 6.

The conveyor 4 has the above-described rollers 11, 12, 21, 22, 31 and 32, a first feeding roller 41, a second feeding roller 42, a third feeding roller 43, and roller pairs 44 to 48. The rollers 11 and 12 are supported by the sheet feed tray 1, the rollers 21 and 22 are supported by the sheet feed tray 2, and the rollers 31 and 32 are supported by the sheet feed tray 3. The first feeding roller 41, the second feeding roller 42, the third feeding roller 43 and the roller pairs 44 to 48 are supported by the casing 100a.

The rollers 11 and 12, the first feeding roller 41 and the roller pairs 44, 47 and 48 are disposed in the first conveyance path T1. The rollers 21 and 22, the second feeding roller 42 and the roller pairs 45, 47 and 48 are disposed in the second conveyance path T2. The rollers 31 and 32, the third feeding roller 43 and the roller pairs 46, 47 and 48 are disposed in the third conveyance path T3.

The roller pairs 44, 47 and 48 are separated from one another in the conveying direction of the roll sheet Rp1 along the first conveyance path T1. The roller pairs 45, 47 and 48 are separated from one another in the conveying direction of the roll sheet Rp2 along the second conveyance path T2. The Roller pairs 46, 47 and 48 are separated from one another in the conveying direction of the roll sheet Rp3 along the third conveyance path T3.

The first to third conveyance paths T1 to T3 join at a joining point Tx, which is disposed between the roller pair 47 and the roller pairs 44 to 46 in the conveying direction. The roller pair 47 is disposed in a common part of the first to third conveyance paths T1 to T3. The roller pair 44 is disposed in the first conveyance path T1, the roller pair 45 is disposed in the second conveyance path T2, and the roller pair 46 is disposed in the third conveyance path T3.

The roller pair 47 corresponds to a “first roller pair” of the present disclosure. The roller pair 47 is disposed upstream of the head 6 in the conveying direction. Another roller pair is not disposed between the roller pair 47 and the head 6 in the conveying direction. The roller pairs 44 to 46 correspond to “second roller pairs” of the present disclosure. Each of the roller pairs 44 to 46 is disposed upstream of the roller pair 47 in the conveying direction. Another roller pair is not disposed between the roller pair 47 and each of the roller pairs 44 to 46 in the conveying direction.

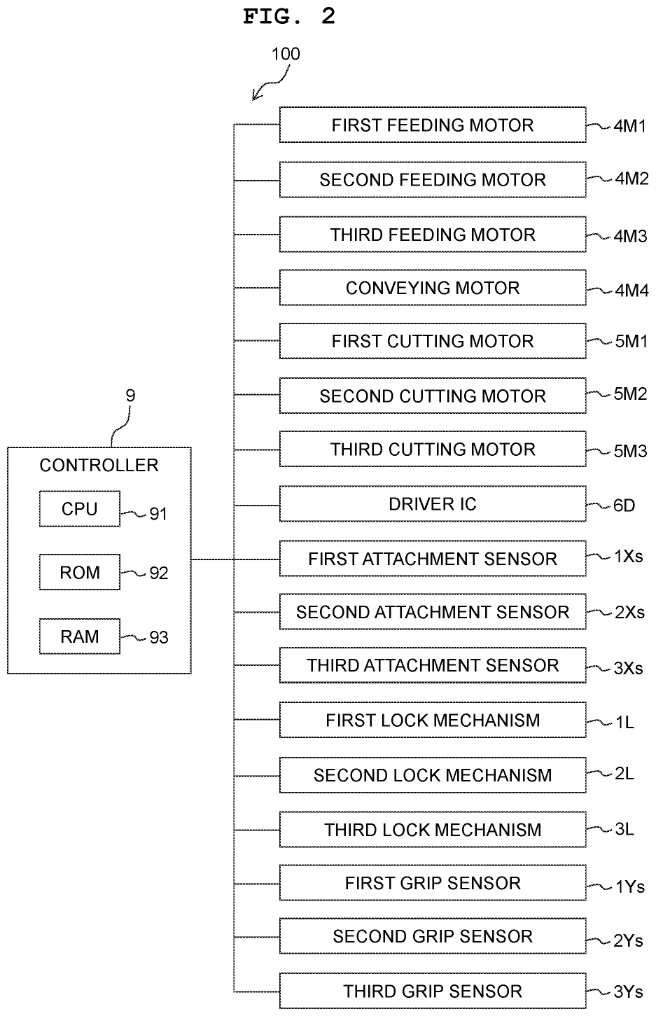

Each of the roller pairs 44 to 48 includes a driving roller and a driven roller which rotates together with the driving roller. In each of the roller pairs 44 to 48, the driving roller is rotated by driving a conveying motor 4M4 (see FIG. 2). The first feeding roller 41 is rotated by driving a first feeding motor 4M1 (see FIG. 2). The second feeding roller 42 is rotated by driving a second feeding motor 4M2 (see FIG. 2). The third feeding roller 43 is rotated by driving a third feeding motor 4M3 (see FIG. 2).

In a case where the first feeding motor 4M1 and the conveying motor 4M4 are driven in a state that the roll body R1 is accommodated in the first accommodating part 10, the feeding roller 41 rotates to thereby cause the roll sheet Rp1 unwound from the roll body R1 to be fed rearward. Accompanying this, the roll body R1 rotates in the direction of an arrow in FIG. 1, thereby causing the rollers 11 and 12 to rotate. The roll sheet Rp1 is fed out to a location above the first sheet feed tray 1 by the feeding roller 41. Further, the roller pairs 44, 47 and 48 rotate while nipping and holding the roll sheet Rp1, thereby causing the roll sheet Rp1 to be conveyed to the sheet discharge tray 7.

In a case where the second feeding motor 4M2 and the conveying motor 4M4 are driven in a state that the roll body R2 is accommodated in the second accommodating part 20, the feeding roller 42 rotates to thereby cause the roll sheet Rp2 unwound from the roll body R2 to be fed rearward. Accompanying this, the roll body R2 rotates in the direction of an arrow in FIG. 1, thereby causing the rollers 21 and 22 to rotate. The roll sheet Rp2 is fed out to a location above the second sheet feed tray 2 by the feeding roller 42. Further, the roller pairs 45, 47 and 48 rotate while nipping and holding the roll sheet Rp2, thereby causing the roll sheet Rp2 to be conveyed to the sheet discharge tray 7.

In a case where the third feeding motor 4M3 and the conveying motor 4M4 are driven in a state that the roll body R3 is accommodated in the third accommodating part 30, the feeding roller 43 rotates to thereby cause the roll sheet Rp3 unwound from the roll body R3 to be fed rearward. Accompanying this, the roll body R3 rotates in the direction of arrow in FIG. 1, thereby causing the rollers 31 and 32 to rotate. The roll sheet Rp3 is fed out to a location above the third sheet feed tray 3 by the feeding roller 43. Further, the roller pairs 46, 47 and 48 rotate while nipping and holding the roll sheet Rp3, thereby causing the roll sheet Rp3 to be conveyed to the sheet discharge tray 7.

In the first conveyance path T1, the first cutting part 51 is disposed upstream of the joining point Tx in the conveying direction and between the first feeding roller 41 and the roller pair 44. The first cutting part 51 includes a fixed blade 5a extending in the left-right direction, and a disc-shaped rotary blade 5b disposed at a position contacting the fixed blade 5a. The rotary blade 5b is moved in the left-right direction by driving a first cutting motor 5M1 (see FIG. 2). With this, the roll sheet Rp1 is cut in the left-right direction.

In the second conveyance path T2, the second cutting part 52 is disposed upstream of the joining point Tx in the conveying direction and between the second feeding roller 42 and the roller pair 45. The second cutting part 52 has a configuration similar to the configuration of the first cutting part 51. The rotary blade of the second cutting part 52 is moved in the left-right direction by driving a second cutting motor 5M2 (see FIG. 2). With this, the roll sheet Rp2 is cut in the left-right direction.

In the third conveyance path T3, the third cutting part 53 is disposed upstream of the joining point Tx in the conveying direction and between the third feeding roller 43 and the roller pair 46. The third cutting part 52 has a configuration similar to the configuration of the first cutting part 51. The rotary blade of the third cutting part 53 is moved in the left-right direction by driving a third cutting motor 5M3 (see FIG. 2). With this, the roll sheet Rp3 is cut in the left-right direction.

The first to third cutting parts 51 to 53 are supported by the casing 100a.

The head 6 corresponds to a “recording part” of the present disclosure. The head 6 is disposed between the roller pair 47 and the roller pair 48 in the conveying direction. The head 6 has a lower surface in which a plurality of nozzles (not depicted) is open. The head 6 may be either of a line system which ejects ink from the nozzles in a fixed state, or of a serial system which ejects the ink from the nozzles while being moved in the left-right direction. In a case where each of the roll sheets Rp1 to Rp3 conveyed by the conveyor 4 passes a location below the head 6, the ink is ejected from the nozzles by driving a driver IC 6D (see FIG. 2). With this, an image is recorded on each of the roll sheets Rp1 to Rp3.

As depicted in FIG. 2, the controller 9 includes a CPU 91, a ROM 92, and a RAM 93. The CPU 91 corresponds to a “controller” of the present disclosure. The ROM 92 stores a program and/or data which the CPU 91 uses so as to perform a variety of kinds of control. Data used by the CUP 91 in a case where the CPU 91 executes the program is temporarily stored in the RAM 93.

A first attachment sensor 1Xs depicted in FIG. 2 transmits a detection signal to the controller 9 in a case where the first sheet feed tray 1 is located at the attachment position. A second attachment sensor 2Xs depicted in FIG. 2 transmits a detection signal to the controller 9 in a case where the second sheet feed tray 2 is located at the attachment position. A third attachment sensor 3Xs depicted in FIG. 2 transmits a detection signal to the controller 9 in a case where the third sheet feed tray 3 is located at the attachment position. The first attachment sensor 1Xs corresponds to a “first sensor” of the present disclosure, and the detection signal transmitted by the first attachment sensor 1Xs corresponds to a “first detection signal”. The second attachment sensor 2Xs corresponds to a “second sensor” of the present disclosure, and the detection signal transmitted by the second attachment sensor 2Xs corresponds to a “second detection signal”. The phrase “the first sheet feed tray 1 is located at the attachment position” means that the roll body R1 is accommodated in the first accommodating part 10 which is located at a predetermined position in the casing 100a. The phrase “the second sheet feed tray 2 is located at the attachment position” means that the roll body R2 is accommodated in the second accommodating part 20 which is located at a predetermined position in the casing 100a.

Each of the first to third attachment sensors 1Xs to 3Xs may be disposed at the attachment position of one of the first to third sheet feed trays 1 to 3 within the casing 100a.

A first lock mechanism 1L depicted in FIG. 2 is configured to lock the first sheet feed tray 1 at the attachment position. A second lock mechanism 2L depicted in FIG. 2 is configured to lock the second sheet feed tray 2 at the attachment position. A third lock mechanism 3L depicted in FIG. 2 is configured to lock the third sheet feed tray 3 at the attachment position.

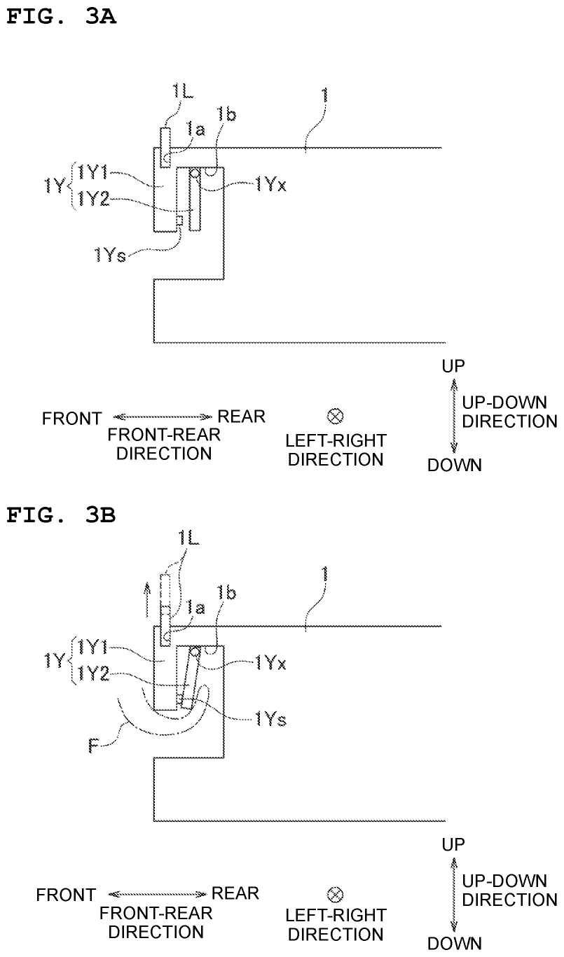

As depicted in FIGS. 3A and 3B, the first lock mechanism 1L has a movable member which is movable in the up-down direction. Under the control of the controller 9, the movable member is moved to a locked position (see FIG. 3A) at which the movable member is inserted into a recessed part 1a of the first sheet feed tray 1 which is located at the attachment position, or to a release position (see a broken line in FIG. 3B), which is above the first sheet feed tray 1. In a case where the movable member is located at the locked position, the first sheet feed tray 1 is locked at the attachment position (i.e., the movement of the first sheet feed tray 1 from the attachment position to the drawn position is prohibited). In a case where the movable member is located at the release position, the movement of the first sheet feed tray 1 from the attachment position to the drawn position is permitted.

The second lock mechanism 2L and the third lock mechanism 3L have a similar configuration to the configuration of the first lock mechanism 1L.

As depicted in FIGS. 3A and 3B, the first sheet feed tray 1 has a first grip part 1Y. The first grip part 1Y includes a wall 1Y1 which constitutes the front surface of the first sheet feed tray 1, and a lever 1Y2 which is swingable about a shaft 1Yx which is along the left-right direction within a recessed part 1b disposed behind the wall 1Y1.

A first grip sensor 1Ys is disposed on the rear surface of the wall 1Y1. In a case where the user moves the first sheet feed tray 1 from the attachment position to the drawn position, the user inserts a finger F into the recessed part 1b and pushes the lever 1Y2 frontward, thereby causing the lever 1Y2 to swing about the shaft 1Yx and to come into contact with the first grip sensor 1Ys. In a case where the lever 1Y2 comes into contact with the first grip sensor 1Ys, the first grip sensor 1Ys transmits a detection signal to the controller 9.

The second sheet feed tray 2 has a second grip part similar to the first grip part 1Y. The third sheet feed tray 3 has a third grip part similar to the first grip part 1Y. A second grip sensor 2Ys (see FIG. 2) similar to the first grip sensor 1Ys is disposed with respect to the second grip part. A third grip sensor 3Ys (see FIG. 2) similar to the first grip sensor 1Ys is disposed with respect to the third grip part.

The first grip sensor 1Ys corresponds to a “third sensor” of the present disclosure, and the detection signal transmitted by the first grip sensor 1Ys corresponds to a “third detection signal”. The second grip sensor 2Ys corresponds to a “fourth sensor” of the present disclosure, and the detection signal transmitted by the second grip sensor 2Ys corresponds to a “fourth detection signal”.

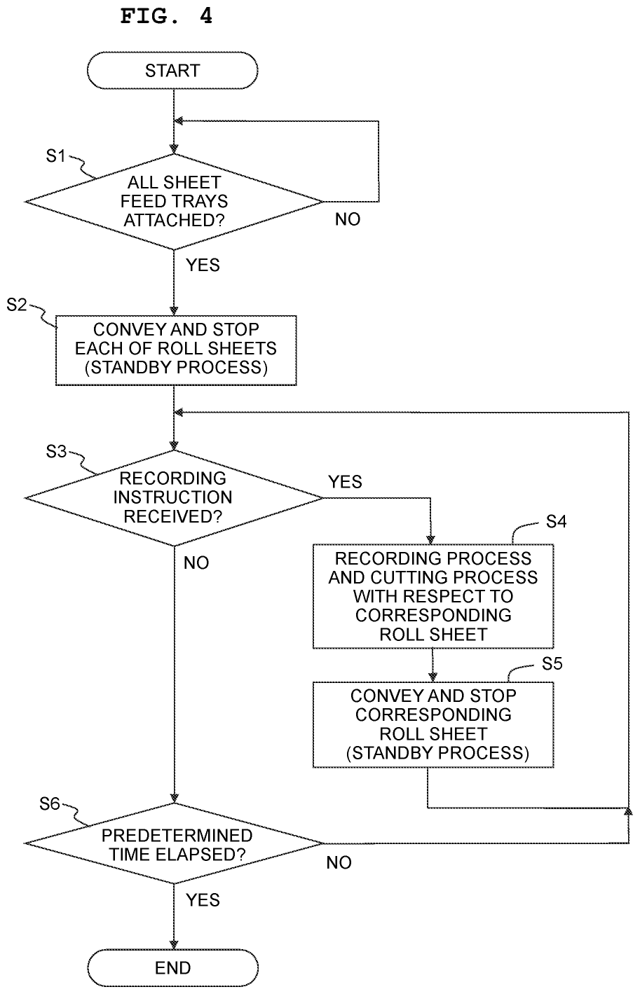

Next, a first program executed by the CPU 91 will be described with reference to FIG. 4.

The CPU 91 first determines whether all the first to third sheet feed trays 1 to 3 have been attached to the casing 100a, based on the detection signals transmitted, respectively, from the first to third attachment sensors 1Xs to 3Xs (step S1). In a case where the CPU 91 receives the detection signals from the first to third attachment sensors 1Xs to 3Xs, the CPU 91 determines that all the first to third sheet feed trays 1 to 3 have been attached to the casing 100a (step S1: YES).

In a case where the CPU 91 determines that any of the first to third sheet feed trays 1 to 3 is not attached to the casing 100a (step S1: NO), the CPU 91 repeats the process of step S1.

In a case where the CPU 91 determines that all the first to third sheet feed trays 1 to 3 have been attached to the casing 100a (step S1: YES), the CPU 91 drives the first to third feed motors 4M1 to 4M3 and the conveying motor 4M4. With this, the conveyor 4 starts conveyance of the roll sheets Rp1 to Rp3, respectively, from the sheet feed trays 1 to 3. In a case where a downstream end (forward end) in the conveying direction of each of the roll sheets Rp1 to Rp3 is located immediately upstream of the joining point Tx (between the joining point Tx and each of the roller pairs 44 to 46 in the conveying direction), the CPU 91 causes the conveyor 4 to stop the conveyance of the roll sheets Rp1 to Rp3 (step S2: a standby process).

In step S2, the CPU 91 may cause the conveyor 4 to simultaneously convey the roll sheets Rp1 to Rp3, or may cause the conveyor 4 to convey the roll sheets Rp1 to Rp3 sequentially. In a case where the roll sheets Rp1 to Rp3 are to be conveyed sequentially, the CPU 91 may cause the conveyor 4 to first convey the roll sheet Rp1 and to stop the conveyance of the roll sheet Rp1, the CPU may cause the conveyor 4 to next convey the roll sheet Rp2 and to stop the conveyance of the roll sheet Rp2, and then the CPU 91 may cause the conveyor 4 to convey the roll sheet Rp3 and then to stop the conveyance of the roll sheet Rp3.

After step S2, the CPU 91 determines whether a recording instruction has been received from an external apparatus such as a PC (step S3).

In a case where the CPU 91 determines that the recording instruction has been received (step S3: YES), the CPU 91 executes a recording process and a cutting process with respect to a roll sheet, among the roll sheets Rp1 to Rp3, which is designated by the recording instruction (step S4). Specifically, the CPU 91 causes the conveyor 4 to convey the designated roll sheet, causes the head 6 to record an image on the designated roll sheet (the recording process), and further causes one of the first to third cutting parts 51 to 53, which corresponds to the designated roll sheet, to cut the designated roll sheet (the cutting process). While the recording process and cutting process for the designated roll sheet are being executed, the other roll sheets are stopped in a state that the forward ends of the other roll sheets are located immediately upstream of the joining point Tx. For example, in a case where the recording instruction designates the roll sheet Rp1, the roll sheets Rp2 and Rp3 are stopped, with the forward ends of the roll sheets Rp2 and Rp3 being located immediately upstream of the joining point Tx, while the recording process and cutting process are being performed with respect to the roll sheet Rp1.

After step S4, the CPU 91 causes the conveyor 4 to convey a part, of the designated roll sheet, for which the recording process has been performed and which has been cut by the cutting process in step S4, namely, a part, of the designated roll sheet, downstream in the conveying direction of the cutting part at a time of the cutting process. Further, the CPU 91 causes the conveyor 4 to convey a part, of the designated roll sheet, upstream in the conveying direction of the cutting part at the time of the cutting process. Furthermore, in a case where the forward end on the downstream in the conveying direction of this part reaches a location immediately upstream of the joining point Tx, the CPU 91 causes the conveyor to stop conveyance of this part (step S5: standby process).

After step S5, the CPU 91 returns the procedure to step S3.

Note that the conveyance as described above is controlled based on signals from encoders each of which is attached to one of the motors 4M1 to 4M4, and signals from sensors each of which is disposed in one of the first to third conveyance paths T1 to T3, etc. The sensors may be disposed, for example, at the joining point Tx, between the first cutting part 51 and the roller pair 44, between the second cutting part 52 and the roller pair 45, between the third cutting part 53 and the roller pair 46, etc.

In a case where the CPU 91 determines that the recording instruction has not been received (step S3: NO), the CPU 91 determines whether a predetermined time has elapsed since the last time when the CPU 91 received the recording instruction (step S6).

In a case where the CPU 91 determines that the predetermined time has not elapsed (step S6: NO), the CPU 91 returns the procedure to step S3.

In a case where the CPU 91 determines that the predetermined time has elapsed (step S6: YES), the CPU 91 ends the program.

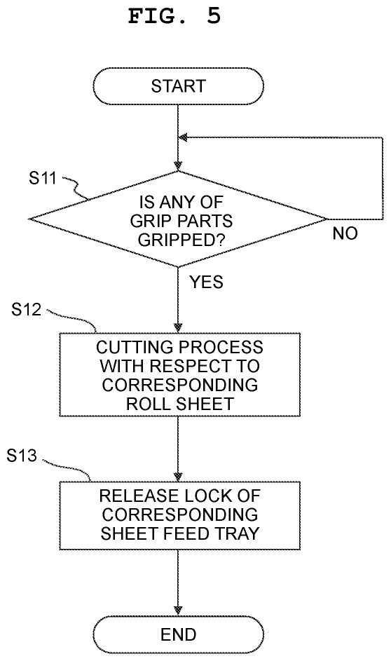

Next, a second program executed by the CPU 91 will be described, with reference to FIG. 5.

The CPU 91 first determines whether any of the grip parts of the first to third sheet feed trays 1 to 3 (see the first grip part 1Y in FIGS. 3A and 3B) is gripped by the user, based on the detection signals transmitted from the first to third grip sensors 1Ys to 3Ys (step S11). In a case where the detection signal is received from any of the first to third first grip sensors 1Ys to 3Ys, the CPU 91 determines that any of the grip parts of the first to third sheet feed trays 1 to 3 is gripped by the user (step S11: YES).

In a case where the CPU 91 determines that none of the grip parts of the first to third sheet feed trays 1 to 3 is gripped by the user (step S11: NO), the CPU 91 repeats the process of step S11.

In a case where the CPU 91 determines that any of the grip parts of the first to third sheet feed trays 1 to 3 is gripped by the user (step S11: YES), the CPU 91 causes the cutting part 5 belonging to a certain sheet feed tray, among the first to third trays 1 to 3, which corresponds to the grip part determined by the CPU 91 as being gripped by the user, to cut the roll sheet accommodated in the certain sheet feed tray (step S12: the cutting process).

After step S12, the CPU 91 drives the lock mechanism of the certain sheet feed tray so as to release the lock (step S13). For example, in the sheet feed tray 1, the CPU 91 moves the movable member, of the first lock mechanism 1L, which is located at the locked position (see FIG. 3A) to the release position (see the dashed line in FIG. 3B). This allows the sheet feed tray to be moved from the attachment position to the drawn position.

After step S13, the CPU 91 ends the program.

Note that the timing at which each of the locking mechanisms LI to L3 is moved from the release position (see dashed line in FIG. 3B) to the locked position (see FIG. 3A) may be a timing at which one of the sheet feed trays 1 to 3 is moved from the drawn position to the attachment position. Alternatively, the timing may be a timing at which the CPU 91 determines that the grip part is gripped by the user (in a case where the movement of each of the sheet feed trays 1 to 3 from the attachment position to the drawn position is detected).

As described above, according to the present embodiment, the joining point Tx is disposed between the roller pair 47 and each of the roller pairs 44 to 46 in the conveying direction (see FIG. 1). Therefore, in a case where switching of the roll sheet which is the object of recording is performed (for example, switching from the roll sheet Rp1 to the roll sheet Rp2 or the roll sheet Rp3 is performed), the roll sheet which is caused to stand by in the state that forward end of the roll sheet is located immediately upstream of the joining point Tx can be quickly conveyed toward the roller pair 47 and the head 6. Therefore, according to the present embodiment, the switching of the roll sheet which is the object of recording can be performed quickly.

In a case where the roll sheet serving as the object of recording is to be switched from the roll sheet Rp1 to the roll sheet Rp2 or the roll sheet Rp3, the CPU 91 executes the recording process with respect to the roll sheet Rp1 in a state that the roll sheets Rp2 and Rp3 are made to stand by so that the forward ends of the roll sheets Rp2 and Rp3 are located immediately upstream of the joining point Tx (during the execution of the standby process) (see step S2 to S4 in FIG. 4). With this, the roll sheet serving as the object of recording can be switched more effectively, (for example, the roll sheet Rp1 can be quickly switched to the roll sheet Rp2 or the roll sheet Rp3 more quickly).

In a case where the CPU 91 determines that all the first to third sheet feed trays 1 to 3 have been attached to the casing 100a (after step S1), the CPU 91 conveys each of the roll sheets Rp1 to Rp3 from one of the sheet feed trays 1 to 3 before the CPU 91 receives the recording instruction (before the determination “YES” in step S3), and the CPU 91 stops the conveyance of the roll sheets Rp1 to Rp3 in a case where the downstream end (forward end) of the conveying direction of each of the roll sheets Rp1 to Rp3 is located immediately upstream of the joining point Tx (between the joining point Tx and each of the roller pairs 44 to 46 in the conveying direction) (step S2: the standby process). This allows the recording to be performed quickly after receiving the recording instruction.

The roll sheets Rp1 to Rp3 which serve as the recording objects are accommodated, respectively, in the accommodating parts 10 to 30, in the state that the roll sheets Rp1 to Rp3 are wound in the roll shape (see FIG. 1). In this case, an image can be recorded on a paper sheet which is longer than a cut sheet.

The cutting parts 51 to 53 are disposed upstream, respectively, of the first to third conveyance paths T1 to T3 corresponding thereto, with respect to the joining point Tx in the conveying direction (see FIG. 1). Provided that the printer 100 has one cutting part which is positioned in a common part of the first to third conveyance paths T1 to T3 (for example, one cutting part which is disposed downstream of the head 6 in the conveying direction), a part, of the roll sheet cut by the common cutting part, which is between the common cutting part and each of the accommodating parts is long. In this situation, in a case where the sheet feed tray which stores the roll sheet is drawn, the sheet feed tray needs to be drawn over a long distance or the sheet feed tray needs to be drawn after rewinding the above-described part which becomes long back to the accommodating part. With respect to this point, according to the present embodiment, since each of the first to third cutting parts 51 to 53 is disposed in an independent part of one of the first to third conveyance paths T1 to T3, the part, of the roll sheet cut by each of the first to third cutting parts 51 to 53, between the accommodating part and each of the first to third cut parts 51 to 53 is short. Therefore, in a case where the sheet feed tray is to be drawn, the distance by which the sheet feed tray is drawn can be short. Alternatively, an operation of unwinding the above-described part back to the accommodating part is simple.

After step S4 (the recording process and the cutting process), the CPU 91 causes the conveyor 4 to convey a part, of the roll sheet, which is upstream in the conveying direction of the cutting part. Further, in a case where the forward end on the downstream in the conveying direction of this part reaches a location immediately upstream in the conveying direction of the joining point Tx, the CPU 91 causes the conveyor 4 to stop the conveyance of this part (step S5: standby process). By causing the roll sheet to stand by in a state that the forward end downstream in the conveying direction is located immediately upstream in the conveying direction of the joining point Tx, a processing according to a subsequent recording instruction can be executed quickly.

In a case where the CPU 91 receives the detection signal from a certain grip sensor among the first to third first grip sensors 1Ys to 3Ys (step S11: YES), the CPU 91 causes the cutting part, among the first to third cutting parts 51 to 53, which corresponds to the certain grip sensor, to cut the roll sheet (step S12), and then causes a certain lock mechanism, among the lock mechanisms LI to L3 to, which corresponds to the certain grip sensor, to release the lock (step S13). In this case, the roll sheets Rp1 to Rp3 which are not cut and long can be prevented from being drawn over a long distance, in a case where the sheet feed trays 1 to 3 are drawn.

### Modification

Although the embodiment of the present disclosure has been described above, the present disclosure is not limited to the above-mentioned embodiment, and various design changes are possible within the scope of the claims.

In the above-described embodiment, although the printer has the three trays, the present disclosure is not limited to this. The printer may have two trays or four or more trays.

The image recording apparatus is not limited to including the plurality of cutting parts positioned in the independent parts of the plurality of conveyance paths, respectively. The image recording apparatus may have one cutting part disposed in a common part of the conveyance paths.

The medium to be the object of recording is not limited to a medium wound in the roll shape. For example, the medium may be a stackable medium such as a cut sheet. For example, the first accommodating part may accommodate a medium wound in the roll shape, and the second accommodating part may accommodate a stackable medium such as a cut sheet.

The sheet-like medium is not limited to paper sheet, and may be, for example, cloth, a resin member, or the like.

The recording part is not limited to a recording part of the liquid ejection system, and may be of the laser type, the thermal transfer system, or the like.

The image recording apparatus according to the present disclosure may be applicable not only to the printer but also to a facsimile, a copier, or the like.

What is claimed is:

1. An image recording apparatus comprising:
a first accommodating part configured to accommodate a first medium;
a second accommodating part configured to accommodate a second medium, the first accommodating part and the second accommodating part being arranged in an up-down direction;
a conveyor configured to selectively convey the first medium and the second medium in a conveying direction; and
a recording part configured to record an image on a medium conveyed by the conveyor,
wherein the conveyor has a plurality of roller pairs which are separated from each other in the conveying direction,
the roller pairs include a first roller pair and a plurality of second roller pairs, the first roller pair being disposed upstream of the recording part in the conveying direction, without another roller pair being interposed between the recording part and the first roller pair in the conveying direction, and each of the second roller pairs being disposed upstream of the first roller pair in the conveying direction, without another roller pair being interposed between the first roller pair and each of the second roller pairs in the conveying direction,
the first medium is conveyed by the conveyor from the first accommodating part toward the recording part along a first conveyance path and the second medium is conveyed by the conveyor from the second accommodating part toward the recording part along a second conveyance path, and
the first conveyance path and the second conveyance path join at a joining point disposed between the first roller pair and the second roller pairs in the conveying direction.

2. The image recording apparatus according to claim 1, further comprising a controller configured to control the conveyor and the recording part,
wherein the second roller pairs include a second roller pair disposed in the first conveyance path and a second roller pair disposed in the second conveyance path,
after the controller has caused the conveyor to start conveyance of the second medium, the controller is configured to execute a standby process of stopping the conveyance of the second medium in a case where a downstream end in the conveying direction of the second medium is located, in the conveying direction, between the joining point and the second roller pair disposed in the second conveyance path, and
while the controller is executing the standby process, the controller is configured to execute a recording process of causing the conveyor to convey the first medium and causing the recording part to record the image on the first medium.

3. The image recording apparatus according to claim 2, further comprising:
a first sensor configured to transmit a first detection signal to the controller in a case where the first medium is accommodated in the first accommodating part; and
a second sensor configured to transmit a second detection signal to the controller in a case where the second medium is accommodated in the second accommodating part,
wherein after the controller has received the first detection signal and the second detection signal and before the controller receives a recording instruction, the controller is configured to:
cause the conveyor to stop conveyance of the first medium, in a case where the controller causes the conveyor to start conveyance of the first medium and then a downstream end in the conveying direction of the first medium is located, in the conveying direction, between the joining point and the second roller pair disposed in the first conveyance path; and
cause the conveyor to stop the conveyance of the second medium, in a case where the controller causes the conveyor to start the conveyance of the second medium and then the downstream end in the conveying direction of the second medium is located, in the conveying direction, between the joining point and the second roller pair disposed in the second conveyance path.

4. The image recording apparatus according to claim 1, wherein
the first medium is accommodated in the first accommodating part in state that the first medium is wound in a roll shape, and
the second medium is accommodated in the second accommodating part in a state that the second medium is wound in a roll shape.

5. The image recording apparatus according to claim 4, further comprising:
a first cutting part configured to cut the first medium; and
a second cutting part configured to cut the second medium,
wherein the first cutting part is disposed upstream of the joining point in the conveying direction in the first conveyance path, and
the second cutting part is disposed upstream of the joining point in the conveying direction in the second conveyance path.

6. The image recording apparatus according to claim 5, further comprising a controller configured to control the conveyor, the recording part, the first cutting part, and the second cutting part,
wherein the controller is configured to execute:
a recording process of causing the conveyor to convey the first medium and causing the recording part to record the image on the first medium; and
a cutting process of causing the first cutting part to cut the first medium, and
after the controller has executed the recording process and the cutting process and then the controller has caused the conveyor to convey the first medium, in a case where a downstream end in the conveying direction of the first medium is located, in the conveying direction, between the joining point and the second roller pair disposed in the first conveyance path, the controller is configured to execute a standby process of causing the conveyor to stop conveyance of the first medium.

7. The image recording apparatus according to claim 5, further comprising:
a casing configured to accommodate the conveyor and the recording part;
a first tray having the first accommodating part, the first tray being movable to a first attachment position at which the first tray is attached to the casing and to a first drawn position at which the first tray is drawn from the casing;
a second tray having the second accommodating part, the second tray being movable to a second attachment position at which the second tray is attached to the casing and to a second drawn position at which the second tray is drawn from the casing;
a first lock mechanism configured to lock the first tray at the first attachment position;
a second lock mechanism configured to lock the second tray at the second attachment position;
a controller configured to control the conveyor, the recording part, the first cutting part, the second cutting part, the first lock mechanism, and the second lock mechanism;
a third sensor configured to transmit a third detection signal to the controller in a case where the first tray is moved from the first attachment position to the first drawn position; and
a fourth sensor configured to transmit a fourth detection signal to the controller in a case where the second tray is moved from the second attachment position to the second drawn position,
wherein in a case where the controller receives the third detection signal, the controller is configured to cause the first cutting part to cut the first medium and then to cause the first locking mechanism to release locking of the first tray to the first attachment position,
in a case where the controller receives the fourth detection signal, the controller is configured to cause the second cutting part to cut the second medium and then to cause the second locking mechanism to release locking of the second tray to the second attachment position, and
in a case where the controller receives both the third detection signal and the fourth detection signal, the controller is configured to cause the first cutting part to cut the first medium and to cause the second cutting part to cut the second medium, and then to cause the first locking mechanism to release the locking of the first tray to the first attachment position and to cause the second locking mechanism to release the locking of the second tray to the second attachment position.
